(19) United States
(12) Patent Application Publication
(10) Pub. No.: US 2017/0277379 A1
(43) Pub. Date: Sep. 28, 2017

(54) METHOD AND TERMINAL FOR PROCESSING DESKTOP ICON

(71) Applicants: Le Holdings (Beijing) Co., Ltd., Beijing (CN); Lemobile Information Technology (Beijing) Co., Ltd., Beijing (CN)

(72) Inventor: Haosen SUO, Beijing (CN)

(21) Appl. No.: 15/256,681

(22) Filed: Sep. 5, 2016

Related U.S. Application Data
(63) Continuation-in-part of application No. PCT/CN2016/096287, filed on Aug. 22, 2016.

(30) Foreign Application Priority Data
Mar. 25, 2016 (CN) 2016101803707

(51) Int. Cl. G06F 3/0486; G06F 3/0488; G06F 3/0481

(52) U.S. Cl. CPC G06F 3/0486; G06F 3/04817; G06F 3/0488

(57) ABSTRACT

Disclosed are method and terminal for processing desktop icon, includes: monitoring an operation behavior of a user for a desktop icon on the terminal; and merging, if it is monitored that the desktop icon on the terminal is dragged to an edge touch area of the terminal, the dragged desktop icon into a designated folder. The embodiment of the present disclosure solves the problem in the prior art that it is complex to perform operations of managing desktop icons, thus leading to high operating costs and low efficiency. In addition, convenient and fast processing of desktop icons is realized, operating costs are lowered, and the efficiency in processing is increased.

### CROSS REFERENCE TO RELATED APPLICATIONS

This application is a continuation-in-part of International Application No. PCT/CN2016/096287, filed on Aug. 22, 2016, which is based upon and claims priority to Chinese Patent Application No. 2016101803707, filed on Mar. 25, 2016, the entire contents of which are incorporated herein by reference.

### TECHNICAL FIELD

The present disclosure relates to the technical field of communications, and more particularly relates to a method and a terminal for processing desktop icon.

### BACKGROUND

With the development and advancement of scientific technologies, use of smart terminals has become more and more popular. To improve efficiency in use and excellent user experience, interaction with users is achieved using a touch screen in most of the existing smart terminals.

Users who use a terminal for the first time will download and install a wide variety of applications according to their own needs, e.g. terminal security applications, communication applications, audio-video applications and the like. These applications of different types bring great conveniences to the users and also enrich their life in spare time.

During the process of implementation of the present disclosure, the inventor has found that at least the following problems exist in the prior art: all types of applications are presented on the screen of the terminal in the form of desktop icons. A vast number of desktop icons will appear on the screen of the terminal as the number of the installed applications increases. In the prior art, the user needs to manage and operate every desktop icon manually, e.g. moving the display positions of the desktop icons manually, or moving every desktop icon into certain folder manually. As a result, it is complex to perform operations of managing desktop icons, thus leading to high operating costs and low efficiency.

### SUMMARY

Given this, provided in the present disclosure are a method and a terminal for processing desktop icon, aiming at solving the problem in the prior art that it is complex to perform operations of managing desktop icons, thus leading to high operating costs and low efficiency.

To achieve the abovementioned inventive object, in an aspect, provided in the embodiment of the present disclosure is a method for processing desktop icon, including: monitoring an operation behavior of a user for a desktop icon on the terminal; and merging, if it is monitored that the desktop icon on the terminal is dragged to an edge touch area of the terminal, the dragged desktop icon into a designated folder.

In the aspect as mentioned above and any possible implementation, further provided is an implementation that merging, if it is monitored that the desktop icon on the terminal is dragged to an edge touch area of the terminal, the dragged desktop icon into a designated folder, includes: creating a folder instantly if it is monitored that the desktop icon on the terminal is dragged to the edge touch area of the terminal, and merging the dragged desktop icon into the instantly created folder.

In the aspect as mentioned above and any possible implementation, further provided is an implementation that the method further includes: acquiring operation information of the user in the edge touch area of the terminal; comparing the operation information of the user in the edge touch area of the terminal with designated operation information; and displaying an icon and a name of the instantly created folder on the desktop of the terminal if the operation information of the user in the edge touch area of the terminal is consistent with the designated operation information.

In the aspect as mentioned above and any possible implementation, further provided is an implementation that the operation information of the user in the edge touch area of the terminal includes operation information generated by a clicking operation of the user in the edge touch area of the terminal; or, operation information generated by a pressing operation of the user in the edge touch area of the terminal; or, operation information generated by a sliding operation of the user in the edge touch area of the terminal.

In the aspect as mentioned above and any possible implementation, further provided is an implementation that the edge touch area of the terminal includes the edge touch area of at least one side on the terminal.

In the aspect as mentioned above and any possible implementation, further provided is an implementation that merging, if it is monitored that the desktop icon on the terminal is dragged to an edge touch area of the terminal, the dragged desktop icon into a designated folder, includes: merging the dragged desktop icon into an existing folder on the desktop of the terminal if it is monitored that the desktop icon on the terminal is dragged to the edge touch area of the terminal.

In the method for processing desktop icon provided in the embodiment of the present disclosure, if it is monitored that the desktop icon on the terminal is dragged to the edge touch area of the terminal, the dragged desktop icon is merged into the designated folder. By managing the desktop icons on the terminal by means of operations in the edge touch area, the embodiment of the present disclosure solves the problem in the prior art that it is complex to perform operations of managing desktop icons, thus leading to high operating costs and low efficiency. In addition, convenient and fast management of desktop icons is realized, operating costs are lowered, and the efficiency in processing is increased.

To achieve the abovementioned inventive object, in yet another aspect, also provided in the embodiment of the present disclosure is a terminal, including: at least one processor; and a memory communicably connected with the at least one processor for storing instructions executable by the at least one processor, wherein execution of the instructions by the at least one processor causes the at least one processor to: monitor an operation behavior of a user for a desktop icon on the terminal; and merge, if it is monitored that the desktop icon on the terminal is dragged to an edge touch area of the terminal, the dragged desktop icon into a designated folder.

To achieve the abovementioned inventive object, in still another aspect, also provided in the embodiment of the present disclosure is a non-transitory computer-readable storage medium storing computer-executable instructions that are used for: monitoring an operation behavior of a user for a desktop icon on the terminal; and merging, if it is monitored that the desktop icon on the terminal is dragged to an edge touch area of the terminal, the dragged desktop icon into a designated folder.

According to the terminal provided in the embodiment of the present disclosure, an operation behavior of a user for a desktop icon on the terminal is monitored by the monitoring module, and when the monitoring module monitors that the desktop icon on the terminal is dragged to an edge touch area of the terminal, the dragged desktop icon is merged into a designated folder by the processing module. By managing the desktop icons on the terminal by means of operations in the edge touch area, the embodiment of the present disclosure solves the problem in the prior art that it is complex to perform operations of managing desktop icons, thus leading to high operating costs and low efficiency. In addition, convenient and fast management of desktop icons is realized, operating costs are lowered, and the efficiency in processing is increased.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of the method for processing desktop icon in accordance with some embodiments of the present disclosure;

FIG. 2 is a flow chart of the method for processing desktop icon in accordance with some embodiments of the present disclosure;

FIG. 3 is a schematic diagram of the first structure of the terminal in accordance with some embodiments of the present disclosure;

FIG. 4 is a schematic diagram of the second structure of the terminal in accordance with some embodiments of the present disclosure; and

FIG. 5 is a schematic diagram of the hardware structure of the terminal, executing the method for processing desktop icon, in accordance with some embodiments of the present disclosure.

### DETAILED DESCRIPTION

The preferred embodiments of the present disclosure will be illustrated below in conjunction with the accompanying drawings. It shall be understood that the preferred embodiments described herein are merely for illustration and explanation of the present disclosure, and are not intended to limit the present disclosure.

It should be clear that the embodiments described are part of the embodiments of the present disclosure only, not all of them. Based on the embodiments in the present disclosure, all the other embodiments obtained by those ordinary skilled in the art without making any creative efforts fall within the scope of protection of the present disclosure.

The terms used in the embodiments of the present disclosure are for the purposes of description of the specific embodiments only, rather than limiting the present disclosure. Unless other meanings are clearly stated in the context, “a”, “said” and “the” in a singular form used in the embodiments of the present disclosure and the appended claims are also intended to include plural forms.

Depending on the context, the term “if”, as used herein, may be interpreted as “while . . . ” or “when . . . ” or “in response to the determination that” or “in response to the detection that”. Similarly, depending on the context, the phrase “if it is determined that” or “if it is detected that (conditions or events stated)” may be interpreted as “when it is determined that” or “in response to the determination that” or “when it is detected that (conditions or events stated)” or “in response to the detection that (conditions or events stated)”.

### Embodiment 1

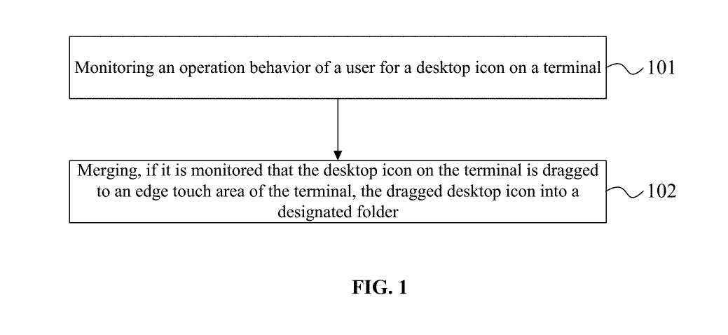

FIG. 1 is a flow chart of the method for processing desktop icon in accordance with some embodiments of the present disclosure. As shown in FIG. 1, the method for processing desktop icon of this embodiment may specifically include the following steps 101-102.

101: An operation behavior of a user for a desktop icon on the terminal is monitored.

The user often downloads and installs some applications according to his own needs while using a terminal. In terminals in the prior art, the number of desktop icons will increase after lots of applications are downloaded and installed. Every time an application is downloaded and installed properly, a desktop icon corresponding to this application will change to appear by default as the last one of all the desktop icons. When the first page is full of desktop icons, the desktop icon corresponding to a new application will be displayed on the second page if this new application is installed. There is typically randomness when the user downloads applications, so if the user needs to use a certain application, this application can only be found after the user turns pages many times, which accordingly results in complex operations.

Because of this, the user will choose to sort and organize a plurality of desktop icons on the desktop of the terminal, e.g., desktop icons of the same type are put together or sorted into the same folder, so that it is quite convenient and fast to find them. For example, a plenty of audio-video desktop icons are put in a folder named ‘audio-video group’, and payment desktop icons are put in a folder named ‘payment’, etc.

Thus in this embodiment, a solution is presented aiming at providing the user with a method for convenient and fast processing of desktop icons and further improving the efficiency in processing and organizing desktop icons.

Operation behaviors of a user for desktop icons on a terminal can be continuously monitored while the terminal is used by the user.

For example, a capacitive touch screen is used as the terminal. A change in the touch screen's capacitor occurs when the user touches the touch screen with his finger, so that the frequency of an oscillator connected with the capacitor changes as well. The touch position can be determined by measuring the change in the frequency of the oscillator, and thus the operation behaviors of the user for the desktop icons on the terminal can be acquired.

102: If it is monitored that the desktop icon on the terminal is dragged to an edge touch area of the terminal, the dragged desktop icon is merged into a designated folder.

The operation behaviors of the user are continuously monitored when the user performs operations, such as clicking, long-pressing and dragging, on desktop icons. And if it is monitored that the desktop icon on the terminal is dragged to the edge touch area of the terminal by the user, the desktop icon is merged into the designated folder by the terminal.

For instance, the dragging operation may be that after a certain desktop icon is clicked, this desktop icon is dragged until it is moved to the edge touch area, and then the screen of the terminal is exited; or, the dragging operation may be that after a certain desktop icon is long-pressed, this desktop icon is thrown with little force to the edge touch area, and the finger leaves the screen of the terminal before the desktop icon reaches the edge touch area.

By way of illustration, merging the dragged desktop icon into the designated folder may include the following two implementations.

The first implementation: if it is monitored that the desktop icon on the terminal is dragged to the edge touch area of the terminal, a folder is created instantly, and the dragged desktop icon is merged into the instantly created folder.

It is understandable that after the desktop icon on the terminal is dragged to the edge touch area of the terminal, a folder can be created instantly, and the dragged desktop icon is merged into the instantly created folder. For example, a new folder is created after the user moves a desktop icon to the edge touch area of the terminal, and the moved desktop icon is merged into this new folder.

The second implementation: the dragged desktop icon is merged into an existing folder on the desktop of the terminal if it is monitored that the desktop icon on the terminal is dragged to the edge touch area of the terminal.

Specifically, if, in the case that a folder has been created on the desktop of the terminal, the user wants to sort other icons than the existing folder and the terminal monitors that the user is moving the desktop icons to the edge touch area of the terminal, then the terminal merges the moved desktop icons into the existing folder. For example, there is a folder named ‘audio-video group’ on the desktop of the terminal, the user moves the desktop icons of applications having music functions to the edge touch area, and the terminal merges these desktop icons into the folder named ‘audio-video group’.

In this embodiment, at least one desktop icon may be included in the instantly created folder.

It is noted that the terminal to which the embodiment of the present disclosure relates may include, but not limited to, personal computers (PC), personal digital assistants (PDA), wireless handheld devices, tablet computers, mobile phones, MP3 players, MP4 players and the like, and the terminal is provided with a screen.

The edge touch area of the terminal may be an area that is accessible by the user's thumb on the sides of the terminal when the user naturally holds the terminal, and the sides of the terminal may include four sides other than front side and back side.

In the embodiment of the present disclosure, the edge touch area of the terminal may be realized using physical buttons, virtual buttons, sensors, screens or the like.

The edge touch area in the embodiment of the present disclosure includes the edge touch area of at least one side on the terminal.

In the method for processing desktop icon provided in the embodiment of the present disclosure, if it is monitored that the desktop icon on the terminal is dragged to the edge touch area of the terminal, the dragged desktop icon is merged into the designated folder. By managing the desktop icons on the terminal by means of operations in the edge touch area, the embodiment of the present disclosure solves the problem in the prior art that it is complex to perform operations of managing desktop icons, thus leading to high operating costs and low efficiency. In addition, convenient and fast management of desktop icons is realized, operating costs are lowered, and the efficiency in processing is increased.

### Embodiment 2

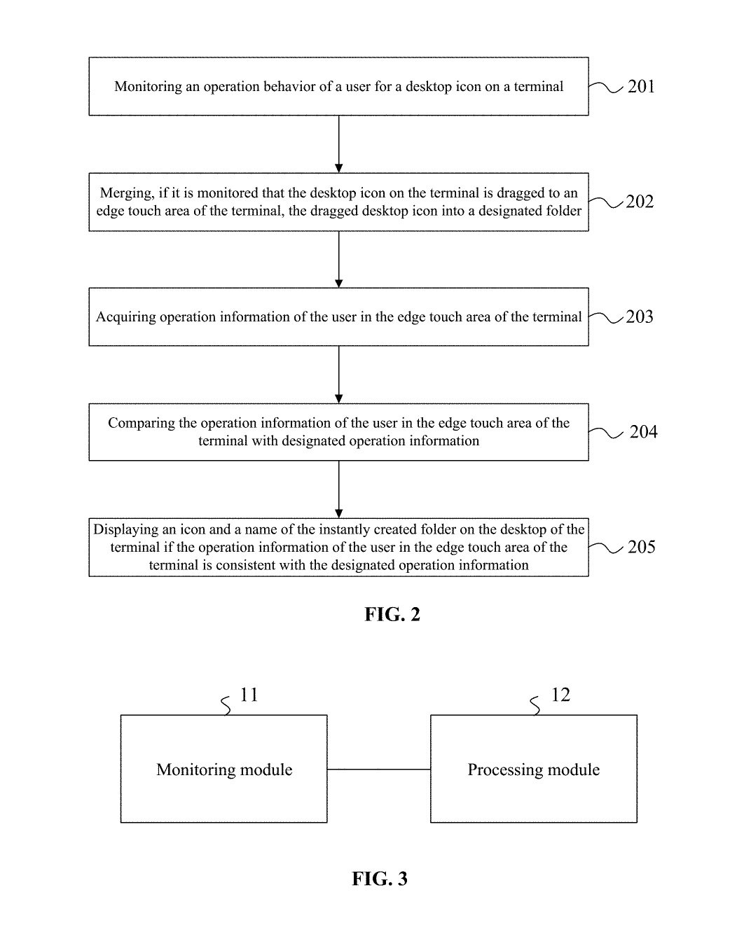

FIG. 2 is a flow chart of the method for processing desktop icon in accordance with some embodiments of the present disclosure. As shown in FIG. 2, the method for processing desktop icon of this embodiment may specifically include the following steps 201-205.

201: An operation behavior of a user for a desktop icon on the terminal is monitored.

For the processing of monitoring the operation behaviors of the user for the desktop icons on the terminal, see the description in step 101 of the above embodiment. The principle and implementation process in the embodiment of the present disclosure are the same and thus detailed description is no longer needed here.

202: If it is monitored that the desktop icon on the terminal is dragged to an edge touch area of the terminal, the dragged desktop icon is merged into a designated folder.

See the description in step 102 of the above embodiment. The principle and implementation process in the embodiment of the present disclosure are the same and thus detailed description is no longer needed here.

203: Operation information of the user in the edge touch area of the terminal is acquired.

In the embodiment of the present disclosure, after the dragged desktop icon is merged into a designated folder, this designated folder is the instantly created folder. The operation information of the user in the edge touch area of the terminal may also be further acquired.

In the embodiment of the present disclosure, the operation information of the user in the edge touch area of the terminal may include, but not limited to: operation information generated by a sliding operation of the user in the edge touch area of the terminal; or operation information generated by a clicking operation of the user in the edge touch area of the terminal; or, operation information generated by a pressing operation of the user in the edge touch area of the terminal.

It is understandable that edge touch means that touch inputs are provided through the edge, frame or back side of the terminal and the operations of tapping, sliding or pressing on the edge of the terminal by a finger are tracked, so as to realize control over the terminal.

For example, if a curved surface screen is used in the terminal, then the edge touch area of the terminal may be realized using the edge screen of this curved surface screen. Take a capacitive touch screen as an example. A change in the touch screen's capacitor occurs when the user touches the edge touch screen with his finger, so that the frequency of an oscillator connected with the capacitance changes as well. The touch position can be determined by measuring the change in the frequency of the oscillator, and thus the operation behaviors of the user in the edge touch area of the terminal can be acquired.

For another example, there are physical buttons for volume control on the edge of the terminal. Take physical buttons for volume control in the terminal as an example. When the user's finger presses the physical buttons for volume control, the terminal will learn whether the physical button for volume-up or the physical button for volume-down is pressed by the user. By the same reasoning, the operation information of the user in the edge touch area of the terminal can be acquired if the user performs a pressing operation in the edge touch area.

For another example, if there are virtual buttons with particular functions on the edge of the terminal and these virtual buttons are capacitive virtual buttons, the terminal judges which virtual button is touched by the user, according to the capacitance of the capacitive virtual button. Specifically, capacitance will be formed together by the user's finger and an electrode slice in the capacitive virtual button when the user touches the capacitive virtual button, the terminal determines the position touched by the user by detecting a change in the capacitance, so that it can be determined which virtual button is touched by the user, and further the operation information of the user in the edge touch area of the terminal can be acquired.

For another example, there are sensors with particular functions on the edge of the terminal. In case that the sensors on the terminal are pressure sensors, a semiconductor deformation pressure is generated on the surface of a sheet of a pressure sensor when this pressure sensor is pressed by the user, the sheet deforms owing to pressing so as to produce a piezoelectric impedance effect. A change in impedance is converted into an electric signal. The terminal, after acquiring the electrical signal, can determine which pressure sensor is pressed by the user or which part of the pressure sensor is pressed by the user, so that it can be determined the pressure sensor with which function is pressed by the user, and further the operation information of the user in the edge touch area of the terminal can be acquired. In addition, the sensors with particular functions on the edge of the terminal may also be optical sensor.

204: The operation information of the user in the edge touch area of the terminal is compared with designated operation information.

In this embodiment, the designated operation information can be preset on the terminal so that the acquired operation information of the user in the edge touch area of the terminal can be compared with the preset designated operation information. The result of comparison is used to judge whether the operation the user is performing is a folder processing operation.

For example, double-clicking the edge touch area is set as the designated operation information, sliding in the edge touch area is set as the designated operation information, or pressing the edge touch area is set as the designated operation information, etc.

205: An icon and a name of the instantly created folder are displayed on the desktop of the terminal if the operation information of the user in the edge touch area of the terminal is consistent with the designated operation information.

When the operation information of the user in the edge touch area of the terminal is consistent with the designated operation information, it can be determined that through the edge touch area, the user is processing the folder into which the dragged desktop icon is merged. Thus in this embodiment, when the operation information of the user in the edge touch area of the terminal is consistent with the designated operation information, the icon and the name of the instantly created folder are displayed on the desktop of the terminal. Wherein the instantly created folder may be displayed on a page where the desktop icons sorted by the user are located, or may also be displayed at the last one of all the desktop icons. And this is not specifically limited in the embodiment of the present disclosure.

For example, if there are virtual buttons with particular functions on the top side of the terminal and these virtual buttons are capacitive virtual buttons, double-clicking the edge touch area is preset as the designated operation information. The user clicks a virtual button on the terminal with his finger, and the terminal judges the user-clicked virtual button from the capacitance of the capacitive virtual button, and further the operation information of the user in the edge touch area of the terminal can be acquired. When the operation performed by the user in the edge touch area of the terminal is double clicking, which is consistent with the preset designated operation information, then the icon and the name of the folder are displayed on the page where the desktop icons sorted by the user are located

For another example, if there are two physical buttons on the left side of the terminal, pressing the edge touch area is preset as the designated operation information. When the user presses these two physical buttons with his finger, the operation information of the user in the edge touch area of the terminal can be acquired. After the user presses the upper one of the two physical buttons, which is consistent with the preset designated operation information, then the icon and the name of the folder are displayed on the last blank of the desktop icons.

For another example, if a curved surface screen is used in the terminal, then the edge touch area of the terminal may be realized using the edge screen of this curved surface screen. Take a capacitive touch screen as an example. The user's index finger slides in the edge touch area on the right side of the terminal, wherein the sliding operation may be sliding up or sliding down. Sliding-up of the user's index finger is preset as the designated operation information. When the edge touch area of the terminal learns that the user's index finger is sliding up, which is consistent with the preset designated operation information, then the icon and the name of the folder are displayed on the last blank of the desktop icons.

In the method for processing desktop icon provided in the embodiment of the present disclosure, if it is monitored that the desktop icon on the terminal is dragged to the edge touch area of the terminal, the dragged desktop icon is merged into the designated folder, and the icon and the name of the folder are displayed on the desktop of the terminal if the operation information of the user in the edge touch area of the terminal is consistent with the preset operation information. By managing the desktop icons on the terminal by means of operations in the edge touch area, the embodiment of the present disclosure solves the problem in the prior art that it is complex to perform operations of managing desktop icons, thus leading to high operating costs and low efficiency. In addition, convenient and fast management of desktop icons is realized, operating costs are lowered, and the efficiency in processing is increased.

### Embodiment 3

The embodiment of the present disclosure further gives a device embodiment that realizes the various steps and methods in the abovementioned method embodiments. FIG. 3 is a schematic diagram of the first structure of the terminal provided in the embodiment of the present disclosure. As shown in FIG. 3, the terminal provided in the embodiment of the present disclosure includes: a monitoring module 11 and a processing module 12.

The monitoring module 11 is used for monitoring an operation behavior of a user for a desktop icon on the terminal.

The processing module 12 is used for merging, if the monitoring module 11 monitors that the desktop icon on the terminal is dragged to an edge touch area of the terminal, the dragged desktop icon into a designated folder.

Wherein the processing module 12 is specifically used for: creating a folder instantly if the monitoring module 11 monitors that the desktop icon on the terminal is dragged to the edge touch area of the terminal, and merging the dragged desktop icon into the instantly created folder.

The processing module 12 is specifically used for: merging the dragged desktop icon into an existing folder on the desktop of the terminal if the monitoring module 11 monitors that the desktop icon on the terminal is dragged to the edge touch area of the terminal.

It is noted that the edge touch area of the terminal in this embodiment includes the edge touch area of at least one side on the terminal.

The terminal of the embodiment of the present disclosure may be used to execute the technical solution of the method embodiment as shown in FIG. 1, and its implementation principle and the technical effect are similar, so detailed description is no longer needed here.

According to the terminal provided in the embodiment of the present disclosure, an operation behavior of a user for a desktop icon on the terminal is monitored by the monitoring module 11, and when the monitoring module 11 monitors that the desktop icon on the terminal is dragged to an edge touch area of the terminal, the dragged desktop icon is merged into a designated folder by the processing module 12. By managing the desktop icons on the terminal by means of operations in the edge touch area, the embodiment of the present disclosure solves the problem in the prior art that it is complex to perform operations of managing desktop icons, thus leading to high operating costs and low efficiency. In addition, convenient and fast management of desktop icons is realized, operating costs are lowered, and the efficiency in processing is increased.

### Embodiment 4

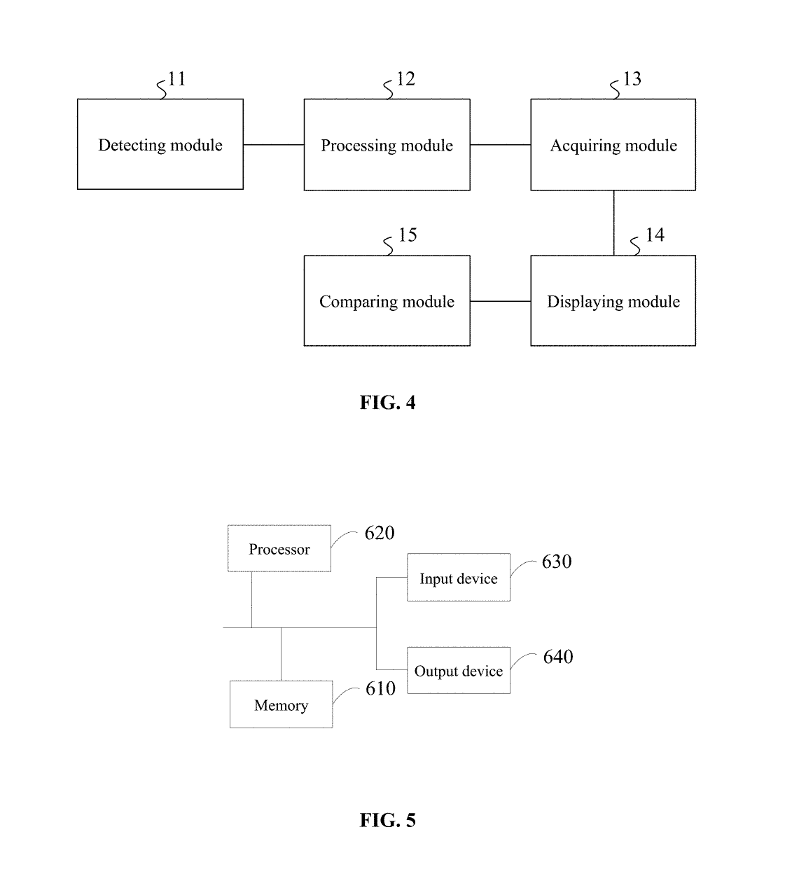

FIG. 4 is a schematic diagram of the second structure of the terminal provided in the embodiment of the present disclosure. As shown in FIG. 4, the terminal provided in the embodiment of the present disclosure, on the basis of the above embodiment, also includes: an acquiring module 13, a comparing module 14 and a displaying module 15.

The acquiring module 13 is used for acquiring the operation information of the user in the edge touch area of the terminal.

The comparing module 14 is used for comparing the operation information of the user in the edge touch area of the terminal acquired by the acquiring module 13 with designated operation information.

The displaying module 15 is used for displaying the icon and the name of the instantly created folder on the desktop of the terminal according to the result of comparison from the comparing module 14 that the operation information of the user in the edge touch area of the terminal is consistent with the designated operation information.

Wherein, the operation information of the user in the edge touch area of the terminal includes: operation information generated by a sliding operation of the user in the edge touch area of the terminal; or, operation information generated by a clicking operation of the user in the edge touch area of the terminal; or, operation information generated by a pressing operation of the user in the edge touch area of the terminal.

The terminal of the embodiment of the present disclosure may be used to execute the technical solution of the method embodiment as shown in FIG. 2, and its implementation principle and technical effect are similar, so detailed description is no longer needed here.

According to the terminal provided in the embodiment of the present disclosure, on the basis of embodiment 3, the operation information of the user in the edge touch area of the terminal is acquired by the acquiring module 13 and then compared with the preset designated operation information by the comparing module 14, and if the operation information is consistent with the preset designated operation information, the icon and the name of the folder are displayed on the desktop of the terminal by the displaying module 15. By managing the desktop icons on the terminal by means of operations in the edge touch area, the embodiment of the present disclosure solves the problem in the prior art that it is complex to perform operations of managing desktop icons, thus leading to high operating costs and low efficiency. In addition, convenient and fast management of desktop icons is realized, operating costs are lowered, and the efficiency in processing is increased.

### Embodiment 5

Provided in the embodiment of the present disclosure is a nonvolatile computer storage medium storing computer-executable instructions that may execute the processing method in any of the above method embodiments.

### Embodiment 6

FIG. 5 is a schematic diagram of the hardware structure of the terminal, executing the method for processing desktop icon, provided in the embodiment of present disclosure. As shown in FIG. 5, the terminal includes:

One or more processors 610 and a memory 620. One processor 610 is exemplified in FIG. 6. The terminal executing the method for processing desktop icon may also include: an input device 630 and an output device 640.

The processor 610, the memory 620, the input device 630 and the output device 640 may be connected with each other via buses or in other ways, and connection via buses is exemplified in FIG. 6.

The memory 620, which serves as a nonvolatile computer-readable storage medium, may be used to store nonvolatile software programs, nonvolatile computer-executable programs and modules. By running the nonvolatile software programs, instructions and modules which are stored in the memory 620, the processor 610 executes a variety of function applications of the terminal and data processing, i.e. the processing method of the above method embodiment is realized.

The memory 620 may include a storage program area and a storage data area, wherein the storage program area may store operating systems, and applications required by at least one function; and the storage data area may store data and the like. Furthermore, the memory 620 may include a high-speed random access memory, and may also include a nonvolatile memory, e.g. at least one magnetic disk memory device, flash memory device, or other nonvolatile solid-state memory devices. In some embodiments, the memory 620 alternatively includes memories disposed remotely from the processor 610, and these remote memories may be connected to a processing device over a network. The examples of the above network include, but not limited to, Internet, Intranet, LAN, mobile communication network or combinations thereof.

The input device 630 may receive input data or character information and produce signal inputs. The output device 640 may include a display screen and other such display equipment.

The one or more modules are stored in the memory 620 and, when executed by the one or more processors 610, are used to execute: monitoring of an operation behavior of a user for a desktop icon on the terminal; and if it is monitored that the desktop icon on the terminal is dragged to an edge touch area of the terminal, merging of the dragged desktop icon into a designated folder.

In a possible implementation, merging, if it is monitored that the desktop icon on the terminal is dragged to an edge touch area of the terminal, the dragged desktop icon into a designated folder, includes: creating a folder instantly if it is monitored that the desktop icon on the terminal is dragged to the edge touch area of the terminal, and merging the dragged desktop icon into the instantly created folder.

In a possible implementation, the method also includes: operation information of the user in the edge touch area of the terminal is acquired; the operation information of the user in the edge touch area of the terminal is compared with designated operation information; and an icon and a name of the instantly created folder on the desktop of the terminal are displayed if the operation information of the user in the edge touch area of the terminal is consistent with the designated operation information.

In a possible implementation, the operation information of the user in the edge touch area of the terminal includes: operation information generated by a clicking operation of the user in the edge touch area of the terminal; or, operation information generated by a pressing operation of the user in the edge touch area of the terminal; or, operation information generated by a sliding operation of the user in the edge touch area of the terminal.

In a possible implementation, the edge touch area of the terminal includes the edge touch area of at least one side on the terminal. In a possible implementation, merging, if it is monitored that the desktop icon on the terminal is dragged to an edge touch area of the terminal, the dragged desktop icon into a designated folder, includes: the dragged desktop icon is merged into an existing folder on the desktop of the terminal if it is monitored that the desktop icon on the terminal is dragged to the edge touch area of the terminal.

The product mentioned above may execute the method provided in the embodiment of the present disclosure, and has the functional modules and beneficial effects corresponding to execution of the method. For those technical details that are not elaborated in this embodiment, reference may be made to the method provided in the embodiment of the present disclosure.

The terminal of the embodiment of the present disclosure takes in many forms including, but not limited to:
Mobile communication equipment: such equipment is featured by possession of mobile communication functions and aims mainly at providing voice and data communications. Such terminals include: smart phones (e.g. iPhone), multimedia phones, functional phones, low-end handsets and the like.
Ultra-mobile personal computer equipment: such equipment, which falls within the category of personal computers, has computation and processing functions and is generally endowed with mobile Internet access characteristics. Such terminals include: PDA, MID and UMPC, etc., such as iPad.
Portable entertainment equipment: such equipment may display and play multimedia contents. Such equipment includes: audio/video players (such as iPod), handheld game consoles, e-books, smart toys and portable vehicular navigation devices.
Servers: equipment providing computational services. Servers consist structurally of processors, hard disks, memory, system buses and the like. Servers are similar to general-purpose computers in the aspect of architecture, but there are higher requirements for their processing capacity, stability, reliability, security, extendibility and manageability because they need to offer high-reliability services.

Other Electronic Devices with Data Interaction Functions.

The device embodiment described hereinabove is merely exemplary, wherein the units that are illustrated as discrete components may be or may not be physically separated, components that are displayed as units may be or may not be physical units, i.e. they may be located at the same place or may be distributed onto a plurality of network units. The object of the solution in this embodiment can be realized by selecting part of or all of the modules therein according to actual needs.

For those skilled in the art, it will be clearly appreciated from the above description of the embodiments that the various embodiments may be realized by means of a combination of software and general-purpose hardware platforms, or certainly by means of hardware. Based on such an understanding, the technical solution above, either in nature or with respect to the parts contributing to related arts, may be embodied in the form of a software product. The computer software product may be stored in a computer-readable storage medium, such as ROM/RAM, magnetic disk, optical disk, etc., and includes several instructions for causing a piece of computer equipment (which may be a personal computer, a server, or network equipment, etc.) to execute the various embodiments or the methods described in some parts of the embodiments.

Finally, it shall be noted that the embodiments above are merely used for illustrating the technical solution of the present application, rather than limitations thereto. While the present application has been detailed with reference to the foregoing embodiments, it shall be appreciated by those ordinary skilled in the art that modifications may still be made to the technical solution stated in the foregoing embodiments, or equivalent substitutions may still be made to a part of the technical features therein; and these modifications or substitutions do not cause the nature of the corresponding technical solution to depart from the spirit and scope of the technical solution of the various embodiments of the present application.

What is claimed is:

1. A method for processing desktop icon, executed by a terminal, comprising:
monitoring an operation behavior of a user for a desktop icon on the terminal; and
merging, if it is monitored that the desktop icon on the terminal is dragged to an edge touch area of the terminal, the dragged desktop icon into a designated folder.

2. The method according to claim 1, wherein the merging, if it is monitored that the desktop icon on the terminal is dragged to an edge touch area of the terminal, the dragged desktop icon into a designated folder, comprises:
creating a folder instantly if it is monitored that the desktop icon on the terminal is dragged to the edge touch area of the terminal, and merging the dragged desktop icon into the instantly created folder.

3. The method according to claim 2, wherein the said method further comprises:
acquiring operation information of the user in the edge touch area of the terminal;
comparing the operation information of the user in the edge touch area of the terminal with designated operation information; and
displaying an icon and a name of the instantly created folder on the desktop of the terminal if the operation information of the user in the edge touch area of the terminal is consistent with the designated operation information.

4. The method according to claim 3, wherein the operation information of the user in the edge touch area of the terminal comprises:
an operation information generated by a clicking operation of the user in the edge touch area of the terminal; or
an operation information generated by a pressing operation of the user in the edge touch area of the terminal; or
an operation information generated by a sliding operation of the user in the edge touch area of the terminal.

5. The method according to claim 3, wherein the edge touch area of the terminal comprises the edge touch area of at least one side on the terminal.

6. The method according to claim 1, wherein the merging, if it is monitored that the desktop icon on the terminal is dragged to an edge touch area of the terminal, the dragged desktop icon into a designated folder, comprises:
merging the dragged desktop icon into an existing folder on the desktop of the terminal if it is monitored that the desktop icon on the terminal is dragged to the edge touch area of the terminal.

7. A terminal, comprising:
at least one processor; and
a memory communicably connected with the at least one processor for storing instructions executable by the at least one processor, wherein execution of the instructions by the at least one processor causes the at least one processor to:
monitor an operation behavior of a user for a desktop icon on the terminal; and
merge, if it is monitored that the desktop icon on the terminal is dragged to an edge touch area of the terminal, the dragged desktop icon into a designated folder.

8. The terminal according to claim 7, wherein the merge, if it is monitored that the desktop icon on the terminal is dragged to an edge touch area of the terminal, the dragged desktop icon into a designated folder, comprises:
creating a folder instantly if it is monitored that the desktop icon on the terminal is dragged to the edge touch area of the terminal, and merging the dragged desktop icon into the instantly created folder.

9. The terminal according to claim 8, wherein execution of the instructions by the at least one processor causes the at least one processor to:
acquire operation information of the user in the edge touch area of the terminal;
compare the operation information of the user in the edge touch area of the terminal with designated operation information; and
display an icon and a name of the instantly created folder on the desktop of the terminal if the operation information of the user in the edge touch area of the terminal is consistent with the designated operation information.

10. The terminal according to claim 9, wherein the operation information of the user in the edge touch area of the terminal comprises:
an operation information generated by a clicking operation of the user in the edge touch area of the terminal; or
an operation information generated by a pressing operation of the user in the edge touch area of the terminal; or
an operation information generated by a sliding operation of the user in the edge touch area of the terminal.

11. The terminal according to claim 8, wherein the edge touch area of the terminal comprises the edge touch area of at least one side on the terminal.

12. The terminal according to claim 7, wherein the merge, if it is monitored that the desktop icon on the terminal is dragged to an edge touch area of the terminal, the dragged desktop icon into a designated folder, comprises:
merging the dragged desktop icon into an existing folder on the desktop of the terminal if it is monitored that the desktop icon on the terminal is dragged to the edge touch area of the terminal.

13. A non-transitory computer-readable storage medium storing computer-executable instructions that are used for:
monitoring an operation behavior of a user for a desktop icon on the terminal; and
merging, if it is monitored that the desktop icon on the terminal is dragged to an edge touch area of the terminal, the dragged desktop icon into a designated folder.

14. The non-transitory computer-readable storage medium according to claim 13, wherein the merging, if it is monitored that the desktop icon on the terminal is dragged to an edge touch area of the terminal, the dragged desktop icon into a designated folder, comprises:
creating a folder instantly if it is monitored that the desktop icon on the terminal is dragged to the edge touch area of the terminal, and merging the dragged desktop icon into the instantly created folder.

15. The non-transitory computer-readable storage medium according to claim 14, wherein the computer-executable instructions are used for:
acquiring operation information of the user in the edge touch area of the terminal;
comparing the operation information of the user in the edge touch area of the terminal with designated operation information; and
displaying an icon and a name of the instantly created folder on the desktop of the terminal if the operation information of the user in the edge touch area of the terminal is consistent with the designated operation information.

16. The non-transitory computer-readable storage medium according to claim 15, wherein the operation information of the user in the edge touch area of the terminal comprises:
an operation information generated by a clicking operation of the user in the edge touch area of the terminal; or
an operation information generated by a pressing operation of the user in the edge touch area of the terminal; or
an operation information generated by a sliding operation of the user in the edge touch area of the terminal.

17. The non-transitory computer-readable storage medium according to claim 15, wherein the edge touch area of the terminal comprises the edge touch area of at least one side on the terminal.

18. The non-transitory computer-readable storage medium according to claim 13, wherein the merging, if it is monitored that the desktop icon on the terminal is dragged to an edge touch area of the terminal, the dragged desktop icon into a designated folder, comprises:
merging the dragged desktop icon into an existing folder on the desktop of the terminal if it is monitored that the desktop icon on the terminal is dragged to the edge touch area of the terminal.
